(19) United States
(12) Patent Application Publication
(10) Pub. No.: US 2008/0080692 A1
(43) Pub. Date: Apr. 3, 2008

(54) SYSTEM AND METHOD FOR JOINING A CONFERENCE CALL OR MULTIMEDIA CONFERENCE

(75) Inventor: Dany Sylvain, Gatineau (CA)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/536,304

(22) Filed: Sep. 28, 2006

(51) Int. Cl. H04M 3/42

(52) U.S. Cl. 379/202.01

(57) ABSTRACT

The present invention provides an efficient way for a conference participant to initiate a call into an audio bridge to join a conference call. To initiate the call into the audio bridge, a multimedia terminal sends to a conference server an address for a telephony terminal, an address for the audio bridge, and an access code. The conference server will instruct a call server to establish a bearer path for the call between the telephony terminal and the audio bridge using the respective addresses. The conference server also provides the access code to the call server, which delivers the access code to the audio bridge in association with establishing the call into the audio bridge. The audio bridge uses the access code to identify the conference call to which the call between the telephony terminal and the audio bridge should join, and adds the call to the conference call.

### FIELD OF THE INVENTION

The present invention relates to conference bridges, and in particular relates to allowing a conference participant to readily join a conference call without having to manually dial into an audio bridge and provide an access code.

### BACKGROUND OF THE INVENTION

Audio bridges allow multiple conference participants from different locations to participate in a conference call. Each audio bridge is generally associated with an address, such as a directory number or uniform resource locator (URL). Each audio bridge may support multiple conference calls, and as such, each conference call is associated with a unique access code. To join a conference call, each conference participant must enter the URL or dial the directory number of the audio bridge to initiate a call to the audio bridge. Once the call is established with the audio bridge, the conference participant must provide the access code to the audio bridge. The access code is usually provided via the bearer path that is established for the call by dialing digits corresponding to the access code. Once the access code is provided, the call into the audio bridge is connected to other calls associated with the other conference participants to facilitate the conference call.

In advance of the conference call, an organizer of the conference call often sends conference call information to the conference participants, which may provide the date and time for the conference call, identify the conference participants, as well as provide the address for the audio bridge and the access code for the conference call. Since the address for the audio bridge and the access code generally comprise numerous numbers, characters, or a combination thereof, initiating a call to the audio bridge using the address for the audio bridge and subsequently providing the access code is prone to human error. Routinely, conference participants make mistakes when entering or dialing long strings of numbers or characters for the address of the audio bridge and the access code. Any mistake generally requires repeating the entire process. If the conference call is associated with a multimedia conference for video conferencing, application sharing, or the like, joining the multimedia conference is prone to similar errors.

Accordingly, there is a need for a mechanism to allow a conference participant to readily join a conference call without having to manually dial into an audio bridge supporting the conference call and then manually provide an access code to the audio bridge to identify the conference call. There is a further need to provide an efficient mechanism to allow the conference participant to readily join a multimedia conference associated with the conference call.

### SUMMARY OF THE INVENTION

The present invention provides an efficient way for a conference participant to initiate a call into an audio bridge to join a conference call. To initiate the call into the audio bridge, a multimedia terminal sends to a conference server an address for a telephony terminal, an address for the audio bridge, and an access code. The conference server will instruct a call server to establish a bearer path for the call between the telephony terminal and the audio bridge using the respective addresses. The conference server also provides the access code to the call server, which delivers the access code to the audio bridge in association with establishing the call into the audio bridge. The audio bridge uses the access code to identify the conference call to which the call between the telephony terminal and the audio bridge should join, and adds the call to the conference call.

In association with establishing the call into the audio bridge for the conference call, the conference server may also obtain multimedia conferencing information to allow the conference participant to join a multimedia conference, which is associated with the conference call and hosted by a multimedia bridge. The conference server may send the multimedia conferencing information to the multimedia terminal, which will use the multimedia conferencing information to join the multimedia conference. The multimedia conferencing information may include the access code for the conference call or other appropriate access code to identify the multimedia conference. Other conference participants may join the conference call or the multimedia conference in the same manner or through conventional techniques.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a communication environment according to one embodiment of the present invention.

FIGS. 2A and 2B are a communication flow illustrating operation of the present invention according to one embodiment.

FIG. 3 is a block representation of a conference server according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention allows a conference participant to readily join a conference call without having to manually dial into an audio bridge supporting the conference call and then manually provide an access code to the audio bridge to identify the conference call. The present invention also allows a conference participant to readily join an associated multimedia conference without having to manually provide the same or different access code. Prior to delving into the details of the present invention, an overview of a communication environment in which the present invention may be employed is provided.

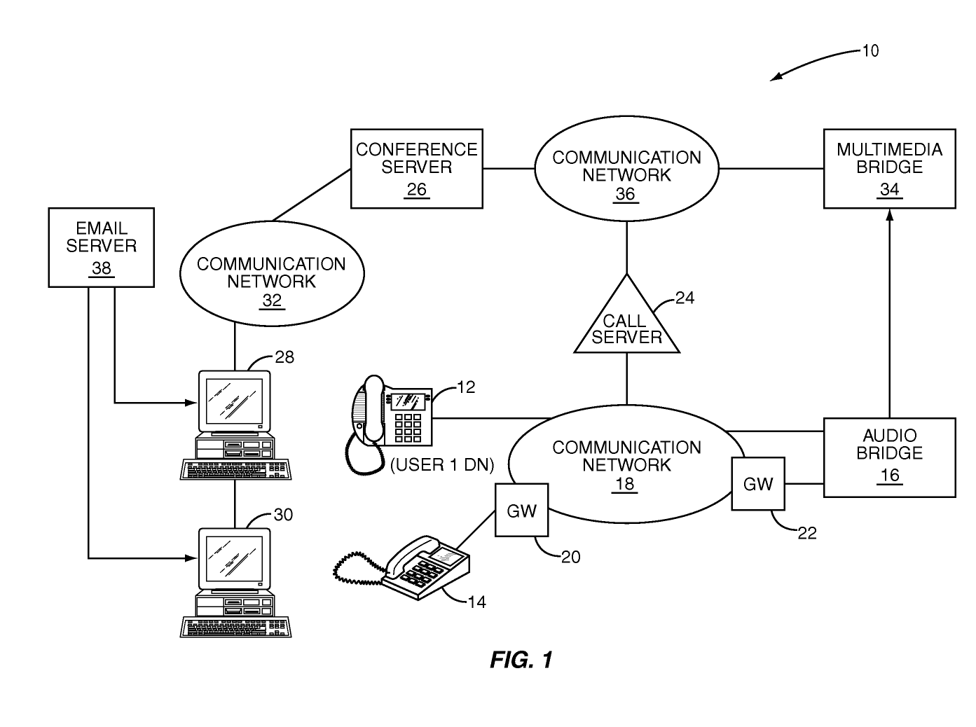

With reference to FIG. 1, a communication environment 10 is illustrated where a packet telephony terminal 12 and a Plain Old Telephone System (POTS) telephony terminal 14 are capable of joining a conference call provided by an audio bridge 16 via a first communication network 18. Although only the packet telephony terminal 12 and the POTS telephony terminal 14 are illustrated, any number and type of telephony terminal may benefit from the present invention. As depicted, the first communication network 18 is a packet-based network, and a first gateway (GW) 20 is used to adapt the circuit-switched communications supported by the POTS telephony terminal 14 to packet-based communications for the first communication network 18. The audio bridge 16 may support packet-based communications, circuit-switched communications, or a combination thereof. A second gateway 22 may be used to adapt packet-based communications of the first communication network 18 to circuit-switched communications for the audio bridge 16. Those skilled in the art will recognize that the illustrated embodiment is merely exemplary and used to only to aid in understanding the broader scope of the present invention. The communication technology and types of telephony terminals used to implement the present invention may take various forms without departing from the essence of the invention.

A call server 24 is provided to initiate calls between the packet telephony terminal 12 or the POTS telephony terminal 14 and the audio bridge 16 directly or via the first and second gateways 20, 22. A click-to-conference (C2C) conference server 26 is adapted to instruct the call server 24 to initiate calls between the packet telephony terminal 12 or the POTS telephony terminal 14 and the audio bridge 16. As illustrated, a first multimedia terminal 28, such as a personal computer, personal digital assistant, or the like is associated with the packet telephony terminal 12, and a second multimedia terminal 30 is associated with the POTS telephony terminal 14. As described in greater detail below, the first or second multimedia terminals 28, 30 allow a conference participant to readily join a conference call by sending an appropriate instruction to the conference server 26, which will respond by instructing the call server 24 to establish a call between the associated packet telephony terminal 12 or the POTS telephony terminal 14 and the audio bridge 16. The multimedia terminals 28, 30 may communicate with the conference server 26 over a second communication network 32.

The conference server 26 may communicate with a multimedia bridge 34, which is capable of providing various multimedia functions in association with a conference call provided by the audio bridge 16. The multimedia bridge 34 may facilitate video conferencing, application sharing, data sharing, and the like among the multimedia terminals 28, 30 to add a multimedia component to a voice-based conference call. A third communication network 36 may provide communications between the conference server 26, call server 24, and the multimedia bridge 34, as well as the multimedia terminals 28, 30. Notably, the first, second, and third communication networks 18, 32, 36 may be part of the same communication network or connected in a fashion to facilitate communications therebetween. An email server 38 is also depicted in FIG. 1 to provide an example of a vehicle through which conference information for a conference call may be provided to the multimedia terminals 28, 30. Those skilled in the art will recognize that the conference information may be provided though any number of mechanisms, such as instant or text messaging services or other communication applications.

The present invention provides an efficient way for a conference participant to initiate a call into an audio bridge 16 to join a conference call. Assume the conference participant is associated with a telephony terminal, such as the packet telephony terminal 12, and a multimedia terminal, such as the multimedia terminal 28. To initiate the call into the audio bridge 16, the multimedia terminal 28 sends to the conference server 26 an address, such as a directory number or uniform resource locator (URL), for the packet telephony terminal 12; an address for the audio bridge 16; and an access code identifying the conference call. The conference server 26 will instruct the call server 24 to establish a bearer path for a call between the packet telephony terminal 12 and the audio bridge 16 using the addresses for the packet telephony terminal 12 and the audio bridge 16. During establishment of the bearer path between the packet telephony terminal 12 and the audio bridge 16, the conference participant may be alerted that the call is being presented to the packet telephony terminal 12. When the packet telephony terminal 12 is answered, the bearer path is connected between the packet telephony terminal 12 and the audio bridge 16. Notably, the conference server 26 also provides the access code to the call server 24, which directly or indirectly delivers the access code to the audio bridge 16 in association with establishing the call into the audio bridge 16. The audio bridge 16 uses the access code to identify the conference call that the call between the packet telephony terminal 12 and the audio bridge 16 should join, and adds the call to the conference call by connecting the bearer paths for all calls from the various conference participants.

To initiate the call into the audio bridge 16, the conference participant may simply select a link for joining the conference call in an electronic document hosted by an application running on the multimedia terminal 28. In one embodiment, the link is associated with the address for the audio bridge 16 and the access code for the conference call. In response to selecting the link, the multimedia terminal 28 may send the address for the audio bridge 16 and the access code to the conference server 26. The conference server 26 may then send a request back to the multimedia terminal 28 to obtain the address for the associated packet telephony terminal 12. If the address for the packet telephony terminal 12 is stored on the multimedia terminal 28 in a cookie or appropriate storage mechanism, the multimedia terminal 28 can automatically provide the address for the packet telephony terminal 12 to the conference server 26.

If the address for the packet telephony terminal 12 is not stored on the multimedia terminal 28 or must be selected from a list of available addresses, the multimedia terminal 28 may request the address for the packet telephony terminal 12 from the conference participant. For example, a window in which the address for the desired packet telephony terminal 12 is requested may be provided to the conference participant. The conference participant may readily respond to the request by entering or selecting the address. Once the address for the packet telephony terminal 12 is determined, the multimedia terminal 28 will provide the address to the conference server 26 for delivery to the call server 24, along with the address for the audio bridge 16 and the access code.

In association with establishing the call into the audio bridge 16 for the conference call, the conference server 26 may also obtain multimedia conferencing information to allow the conference participant to join a multimedia conference, which is associated with the conference call and hosted by the multimedia bridge 34. The conference server 26 may send the multimedia conferencing information to the multimedia terminal 28, which will use the multimedia conferencing information to join the multimedia conference. The multimedia conferencing information may include the access code for the conference call or other appropriate access code to identify the multimedia conference corresponding to the conference call. Other conference participants may join the conference call or the multimedia conference in the same manner or through conventional techniques.

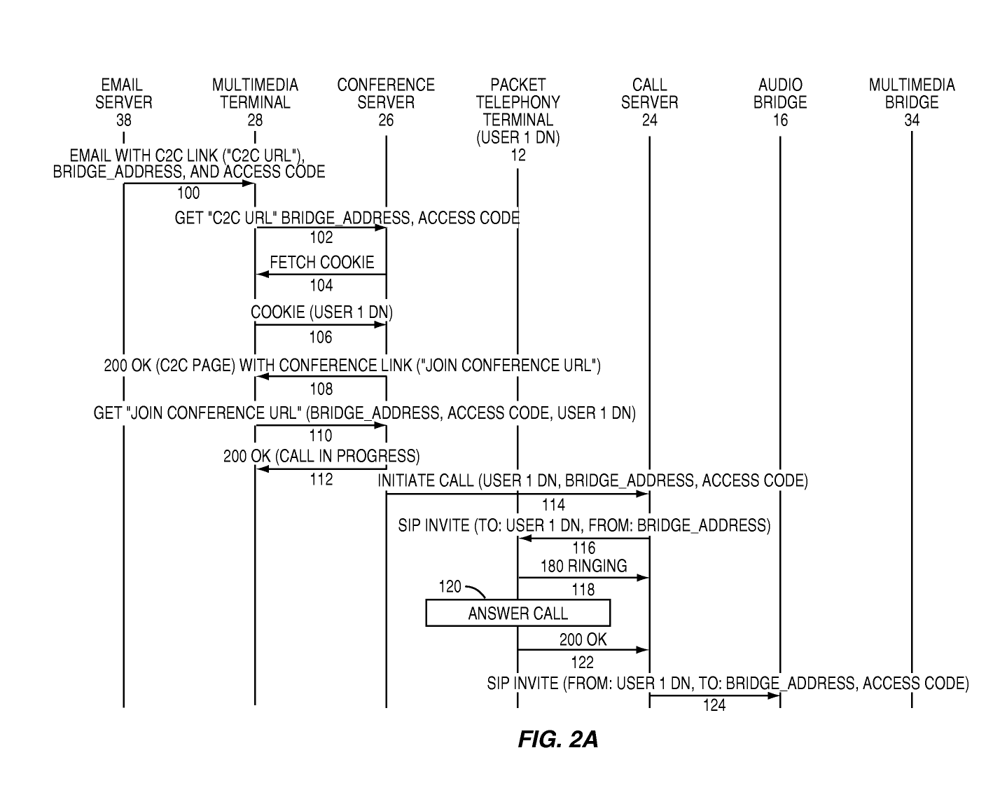

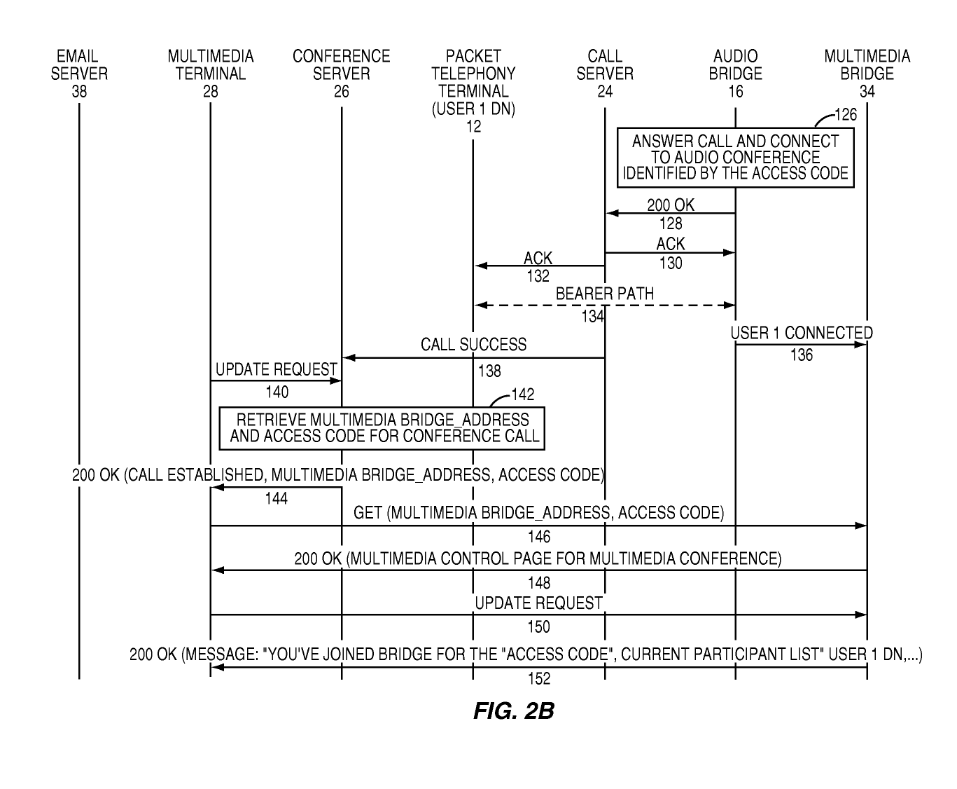

Turning now to FIGS. 2A and 2B, a communication flow is provided to illustrate how a conference participant associated with the multimedia terminal 28 and the packet telephony terminal 12 can join a conference call hosted by the audio bridge 16. The communication flow also illustrates allowing the conference participant to readily join a multimedia conference, which is hosted by the multimedia bridge 34 and associated with the conference call. Initially, assume that the multimedia terminal 28 receives an email via the email server 38 (step 100). The email includes a “click-to-call” (C2C) link (“C2C URL”), which points to the conference server 26. The C2C link is also associated with a bridge address for the audio bridge 16, and an access code identifying the conference call that the conference participant will join. When the link is selected by the conference participant, the multimedia terminal 28 will send a HTTP Get message to the conference server 26 using the C2C URL associated with the conference server 26, along with the bridge address for the audio bridge 16, and the access code for the conference call (step 102). The conference server 26 will respond by fetching a cookie or like information identifying the directory number or address corresponding to the packet telephony terminal 12 that is associated with the multimedia terminal 28. As such, the conference server 26 will send a message to fetch the cookie to the multimedia terminal 28 (step 104), which will respond with the cookie information identifying the directory number (USER 1 DN) for the packet telephony terminal 12 (step 106). The conference server 26 will then create a C2C page with a conference link (“JOIN CONFERENCE URL”) and send it to the multimedia terminal 28 in a 200 OK message (step 108). The multimedia terminal 28 may display the C2C page in a browser or other appropriate application to the conference participant.

At this point, the conference server 26 has the address or directory number for the packet telephony terminal 12, the address for the audio bridge 16, and the access code for the conference call. The multimedia terminal 28 is presenting the C2C page to the conference participant. The C2C page will present the conference link to the conference participant, wherein when the conference link is selected, a process to join the conference call via the packet telephony terminal 12 is initiated.

Once the conference link is selected, the multimedia terminal 28 will send a HTTP Get message to the conference server 26 using the JOIN CONFERENCE URL (step 110). The HTTP Get message may include the bridge address for the audio bridge 16, the access code, and the directory number for the packet telephony terminal 12. The conference server 26 will respond to the multimedia terminal 28 with a 200 OK message indicating that a call into the audio bridge 16 is in progress (step 112). The conference server 26 will then provide an Initiate Call message to the call server 24 to initiate a call between the packet telephony terminal 12 and the audio bridge 16 (step 114). The Initiate Call message will include the directory number (USER 1 DN) for the packet telephony terminal 12 and the bridge address for the audio bridge 16 for the call server 24 to use in establishing the call between the packet telephony terminal 12 and the audio bridge 16. Notably, the Initiate Call message also provides the access code to the call server 24, which will subsequently deliver the access code to the audio bridge 16, as illustrated below.

In response to the Initiate Call message, the call server 24 will take the necessary steps to establish a bearer path between the packet telephony terminal 12 and the audio bridge 16. In this example, the Session Initiation Protocol (SIP) is used to initiate a packet-based communication session, representing a bearer path, between the packet telephony terminal 12 and the audio bridge 16. Those skilled in the art will recognize that circuit-switched bearer paths may also be provided between other gateways or circuit-switched devices to facilitate a bearer path into the audio bridge 16 for the conference call. To establish the bearer path, the call server 24 may send a SIP Invite message to the packet telephony terminal 12, wherein the SIP Invite message is configured to indicate that a call is being initiated to a directory number (USER 1 DN) associated with the packet telephony terminal 12 from the bridge address of the audio bridge 16 (step 116). The packet telephony terminal 12 will respond by sending a 180 Ringing message back to the call server 24 (step 118) and will take the necessary steps to answer the call (step 120). Once answered, the packet telephony terminal 12 will send a 200 OK message back to the call server 24 (step 122).

The call server 24 will also send a SIP Invite message to the audio bridge 16 to indicate that a session is being initiated to the audio bridge 16 using the bridge address from the packet telephony terminal 12 using the directory number (USER 1 DN) for the packet telephony terminal 12 (step 124). The access code for the conference call may be provided to the audio bridge 16 in the SIP Invite message. The audio bridge 16 may then answer the call and connect to the audio conference identified by the access code (step 126), as well as respond to the SIP Invite message by providing a 200 OK message back to the call server 24 (step 128). The call server 24 will acknowledge the 200 OK message received from the audio bridge 16 by sending an Acknowledgment message (ACK) back to the audio bridge 16 (step 130). The call server 24 will respond to the 200 OK message received from the packet telephony terminal 12 after receiving the 200 OK message from the audio bridge 16, by sending an Acknowledgement message to the packet telephony terminal 12 (step 132). During this message exchange, the Session Description Protocol (SDP) provided within the SIP message exchange has provided sufficient information between the packet telephony terminal 12 and the audio bridge 16 to establish a bearer path (or communication session) between the packet telephony terminal 12 and the audio bridge 16 (step 134). Once the bearer path is established, the audio bridge 16 may send a message to an associated multimedia bridge 34 to indicate that the conference participant (User 1) is connected to the conference call (step 136).

The call server 24 may send a Call Success message back to the conference server 26 to indicate that the conference participant is successfully engaged in the conference call via the packet telephony terminal 12 (step 138). The conference server 26 will maintain the relative status of the conference participant with respect to the conference call. The multimedia terminal 28 may send systematic Update Request messages to the conference server 26 to obtain conference-related updates or instructions (step 140). If the multimedia bridge 34 is providing multimedia conferencing functionality in association with the conference call, the conference server 26 may retrieve a corresponding multimedia bridge address for the conference call, and a corresponding access code, which may be the same access code used for the conference call (step 142). In response to the Update Request message, the conference server 26 may send a 200 OK message to the multimedia terminal 28 indicating that the call into the audio bridge for the conference call was established (step 144). The 200 OK message may also include the address for the multimedia bridge 34 and the access code for the multimedia conference. The multimedia terminal 28 may present information to the conference participant to allow the conference participant to join the multimedia conference, preferably by simply selecting an appropriate link. Alternatively, the conference participant may be automatically joined to the multimedia conference upon joining the conference call.

Once the multimedia terminal 28 decides to join the multimedia conference, a HTTP Get message is sent to the multimedia bridge 34 using the multimedia bridge address to join the multimedia conference (step 146). The HTTP Get message may include the access code, which identifies the particular multimedia conference that is associated with the conference call. The multimedia bridge 34 will take the necessary action to engage the multimedia terminal 28 in the multimedia conference. For example, the multimedia bridge 34 may generate a multimedia control page for the multimedia conference, and provide the multimedia control page to the multimedia terminal 28 in a 200 OK message (step 148). The multimedia terminal 28 may use the multimedia control page for providing information for the multimedia conference to the multimedia bridge 34, as well as receiving information from the multimedia conference for display to the conference participant.

The multimedia conference may support video streaming, such that active conference participants may be viewed at the various multimedia terminals 28, 30, as well as receive content corresponding to applications or content sharing applications. Those skilled in the art will recognize various multimedia conferencing capabilities that are beyond the scope of the present invention. The present invention provides an effective and efficient way for allowing a conference participant to join a conference call and perhaps an associated multimedia conference without having to manually enter access codes. Further, joining the conference call and the multimedia conference may take place with a simple click or like selection of an associated conference link, when the directory number or address associated with the packet telephony terminal 12 or the POTS telephony terminal 14 is known by the associated multimedia terminal 28 or 30, respectively.

Once the multimedia terminal 28 joins the multimedia conference, the multimedia bridge 34 may respond to Update Request messages from the multimedia terminal 28 (step 150) with multimedia conference updates (step 152). As illustrated, one of the initial responses to an Update Request message may include a message indicating that the conference participant has joined a particular bridge associated with the access code and identify the other conference participant that are participating in the conference call, multimedia conference, or both.

In the example provided above, the access code is delivered from the multimedia terminal 28 to the call server 24 via the conference server 26. The call server 24 provides the access code to the audio bridge 16, such that the conference participant can automatically join the audio bridge 16 without having to manually enter the access code. Further, the conference server 26 operates to obtain the address or directory number information associated with the corresponding packet telephony terminal 12 in a manner making initiation of the call into the audio bridge 16 very efficient. Efficiency is optimized when the addressing or directory number for the associated packet telephony terminal 12, or any other terminal, is stored on the multimedia terminal 28 and is automatically retrieved from the conference server 26 and delivered to the call server 24, which will use the bridge address and the address or directory number information associated with the packet telephony terminal 12 to initiate the call into the audio bridge 16. As such, the call into the audio bridge 16 is automatically established, and the access code is automatically provided with minimal interaction required by the conference participant. In a preferred embodiment, the conference participant may join the conference call without dialing the address or directory number associated with the audio bridge 16 or entering the access code for the conference call. Further, any associated multimedia conferences may be automatically joined without manually entering an address for the multimedia bridge 34 or an access code for the multimedia conference hosted by the multimedia bridge 34.

In a circuit-switched environment where a connection between the POTS telephony terminal 14 or other circuit-switched terminal is used to gain access to a conference call, the call server 24 may instruct an affiliated gateway, such as the first gateway 20 or the second gateway 22, to provide the access code after a call has been established with the audio bridge 16. As such, the access code may be provided to the audio bridge 16 using dual tone multi-frequency (DTMF) dialing via the bearer path established between the gateway and the audio bridge 16. Further, the call server 24 may provide the access code to the audio bridge 16 in the same or difference messages than those messages used to establish the bearer path between the designated telephony terminal or gateway and the audio bridge 16. Although SIP is employed in the above example, any appropriate communication protocol may be used to exchange information between the entities described above, establish bearer paths, and deliver the access code in an automated fashion from the conference server 26 to the audio bridge 16 via the call server 24.

In addition to delivering the access code in an automated fashion, passwords required from one or more of the conference participants to join a conference call may be delivered along with the access code or in a fashion similar to that in which the access code is delivered. If it is required that the conference participant manually provide the password, the password may be entered at the multimedia terminal 28 and passed to the audio bridge 16 via the conference server 26 and perhaps the call server 24.

The call server 24 may be a standalone entity or may be integrated with the audio bridge 16 or other service node. The multimedia bridge 34 may be able to provide different types of multimedia services. Alternatively, different multimedia bridges 34 may be provided for each service provided for the multimedia conference. For example, one multimedia bridge 34 may support instant messaging, wherein another supports content or application sharing. Although the example above only illustrates one conference participant calling into a conference call and joining a multimedia conference provided by the multimedia bridge 34, multiple conference participants may join the conference call and may join multiple multimedia conferences associated with the conference call.

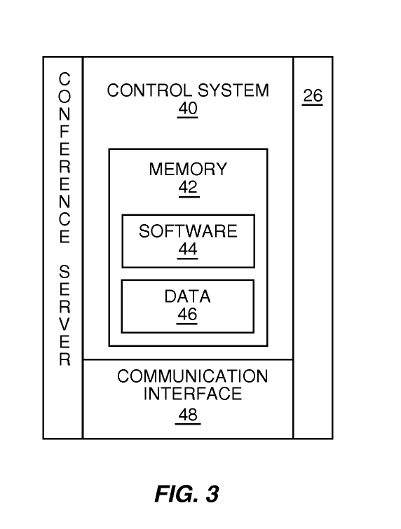

Turning now to FIG. 3, a block representation of a conference server 26 is illustrated. The conference server 26 will include a control system 40 having sufficient memory 42 for the requisite software 44 and data 46 to operate as described above. The control system 40 is associated with a communication interface 48 to facilitate communications with the various entities in the communication environment 10, as described above.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving conference information from a multimedia terminal associated with a telephony terminal, the conference information comprising an access code identifying a conference call supported by an audio bridge;
effecting establishment of a call between the telephony terminal and the audio bridge to enable the telephony terminal to join the conference call; and
effecting delivery of the access code to the audio bridge for conference call.

2. The method of claim 1 wherein the access code is provided to the multimedia terminal in association with a link in an electronic document and delivered from the multimedia terminal in response to a user selecting the link.

3. The method of claim 1 wherein the access code is not manually entered at the multimedia terminal in association with joining the conference call.

4. The method of claim 1 wherein the conference information further comprises an address for the audio bridge and an address for the telephony terminal, and the call is established using the address for the audio bridge and the address for the telephony terminal.

5. The method of claim 4 wherein receiving the conference information comprises:
receiving from the multimedia terminal a message to initiate the call between the telephony terminal and the audio bridge;
sending to the multimedia terminal a request to obtain the address for the telephony terminal; and
receiving from the multimedia terminal the address for the telephony terminal.

6. The method of claim 5 wherein the access code is provided in the message.

7. The method of claim 6 wherein the address for the audio bridge is provided in the message.

8. The method of claim 4 wherein the address for the audio bridge is not manually entered at the multimedia terminal in association with joining the conference call.

9. The method of claim 1 wherein effecting establishment of the call between the telephony terminal and the audio bridge further comprises sending call initiation instructions to a call server to initiate the call between the telephony terminal and the audio bridge, such that the call server will initiate the call between the telephony terminal and the audio bridge.

10. The method of claim 9 wherein effecting delivery of the access code to the audio bridge further comprises sending the access code to the call server in association with the sending the call initiation instructions to the call server, such that the call server will effect delivery of the access code to the audio bridge.

11. The method of claim 9 wherein effecting delivery of the access code to the audio bridge further comprises sending the access code to the call server in association with the sending the call initiation instructions to the call server, such that the call server will effect delivery of the access code to the audio bridge by instructing a gateway to send dual tone multi-frequency tones representing the access code to the audio bridge.

12. The method of claim 1 further comprising:
retrieving an address for a multimedia bridge, which provides multimedia conferencing associated with the conference call; and
sending to the multimedia terminal multimedia conference information to enable the multimedia terminal to join a multimedia conference.

13. The method of claim 12 wherein the multimedia conference information comprises an access code required to join the multimedia conference.

14. The method of claim 1 further comprising
retrieving a password for joining the conference call from the multimedia terminal; and
effecting delivery of the password to the audio bridge.

15. A system comprising:
at least one communication interface; and
a control system associated with the at least one communication interface and adapted to:
receive conference information from a multimedia terminal associated with a telephony terminal, the conference information comprising an access code identifying a conference call supported by an audio bridge;
effect establishment of a call between the telephony terminal and the audio bridge to enable the telephony terminal to join the conference call; and
effect delivery of the access code to the audio bridge for the conference call.

16. The system of claim 15 wherein the access code is provided to the multimedia terminal in association with a link in an electronic document, and delivered from the multimedia terminal to the system in response to a user selecting the link.

17. The system of claim 15 wherein the access code is not manually entered at the multimedia terminal in association with joining the conference call.

18. The system of claim 15 wherein the conference information further comprises an address for the audio bridge and an address for the telephony terminal, and the call is established using the address for the audio bridge and the address for the telephony terminal.

19. The system of claim 18 wherein to receive the conference information, the control system is further adapted to:
receive from the multimedia terminal a message to initiate the call between the telephony terminal and the audio bridge;
send to the multimedia terminal a request to obtain the address for the telephony terminal; and
receive from the multimedia terminal the address for the telephony terminal.

20. The system of claim 19 wherein the access code is provided in the message.

21. The system of claim 20 wherein the address for the audio bridge is provided in the message.

22. The system of claim 18 wherein the address for the audio bridge is not manually entered at the multimedia terminal in association with joining the conference call.

23. The system of claim 15 wherein to effect establishment of the call between the telephony terminal and the audio bridge, the control system is further adapted to send call initiation instructions to a call server to initiate the call between the telephony terminal and the audio bridge, such that the call server will initiate the call between the telephony terminal and the audio bridge.

24. The system of claim 23 wherein to effect delivery of the access code to the audio bridge, the control system is further adapted to send the access code to the call server in association with the sending the call initiation instructions to the call server, such that the call server will effect delivery of the access code to the audio bridge.

25. The system of claim 15 wherein the control system is further adapted to:
retrieve an address for a multimedia bridge, which provides multimedia conferencing associated with the conference call; and
send to the multimedia terminal multimedia conference information to enable the multimedia terminal to join a multimedia conference.

26. The system of claim 25 wherein the multimedia conference information comprises an access code required to join the multimedia conference.

27. The system of claim 15 wherein the control system is further adapted to:
retrieve a password for joining the conference call from the multimedia terminal; and
effect delivery of the password to the audio bridge.
